(19) United States
(12) Patent Application Publication
(10) Pub. No.: US 2024/0242165 A1
(43) Pub. Date: Jul. 18, 2024

(54) Information Processing System, Management Method of Warehouse, and Warehouse Control Apparatus

(71) Applicant: Hitachi Industrial Products, Ltd., Chiyoda-ku, Tokyo (JP)

(72) Inventors: Shinji TAKEDA, Tokyo (JP); Suguru MOTOYAMA, Tokyo (JP)

(21) Appl. No.: 18/559,845

(22) PCT Filed: May 9, 2022
(86) PCT No.: PCT/JP2022/019700

§ 371 Date: Nov. 9, 2023

(30) Foreign Application Priority Data
Jun. 23, 2021 (JP) 2021-103716

(51) Int. Cl. G06Q 10/083; G06Q 10/0639

(52) U.S. Cl. CPC G06Q 10/083; G06Q 10/06398

(57) ABSTRACT

An information processing system includes a transportation device that is controlled by a warehouse control apparatus and can transport a storage portion storing a product; and a terminal that transmits and receives work information at a work station that is connected to the warehouse control apparatus and one or more types of work related to warehousing or shipping is performed on the product of the storage portion, in which the warehouse control apparatus includes a storage unit that stores information related to work performance of warehousing and shipping in the work station from the terminal as log information, and a control unit that generates a plurality of pieces of performance data related to working time during a plurality of preset periods with different lengths per type of the one or more types of work based on the log information and estimates predicted working time of each of the at least one work based on the plurality of pieces of performance data.

### CROSS-REFERENCE TO RELATED APPLICATION

This application claims priority to Japanese Patent Application No. 2021-103716, which was filed on Jun. 23, 2021, and its contents are incorporated into this application by reference.

### TECHNICAL FIELD

The present invention relates to an information processing system that predicts work in a distribution center, management method of a warehouse, and a warehouse control apparatus.

### BACKGROUND ART

An example of a distribution center or distribution warehouse is one in which delivered products are stored, and when an order is received, the corresponding products are taken out by a picking work, sorted and packed by an assortment work, and then shipped to a customer.

As an example of a technique for predicting working time in a distribution center, JP-A-2001-322707 (PTL 1) is provided.

### CITATION LIST

### Patent Literature

PTL 1: JP2001-322707A

### SUMMARY OF INVENTION

### Technical Problem

Delays in work at distribution centers lead to delays in subsequent transportation and delivery, leading to increased costs. Therefore, in order to make appropriate management decisions such as increasing the number of personnel in locations that are likely to cause delays, it is required to accurately predict the end times of various works within a distribution center and grasp delays in work. Here, the inventor of the present application discovered that there are various types of variable factors that affect the working time of various works in a distribution center. For example, we have found that in addition to differences in work efficiency by workers on the work day, various working times also vary due to deviation in the types and locations of merchandises shipped due to seasons and trends.

The inventors found that, for example, recent work performance strongly reflects deviations in workers and temporary orders, whereas work performance over a long period of time reflects the fluctuations in various working time due to the occurrence of deviations in the type and location of merchandises shipped depending on seasons and trends.

The present invention has been made in view of the above-mentioned problems, and an object of the present invention is to predict working time in a distribution center by considering various variable factors that affect working time.

### Solution to Problem

The present invention provides an information processing system including: a warehouse control apparatus that includes a processor and a memory; a transportation device that can transport a storage portion storing a product according to a transportation instruction from the warehouse control apparatus; and a terminal that transmits and receives work information at a work station that is connected to the warehouse control apparatus and where at least one work related to warehousing or shipping is performed on the product of the storage portion, in which the warehouse control apparatus includes a storage unit that acquires information related to work performance in the work information related to at least one of warehousing and shipping in the work station from the terminal and stores the information as log information, and a control unit that generates a plurality of pieces of performance data that is information related to working time during a plurality of preset periods with different lengths per type of the at least one work based on the log information and estimates predicted working time of each of the at least one work based on the plurality of pieces of performance data.

### Advantageous Effects of Invention

Therefore, according to the present invention, prediction of working time with high accuracy can be realized based on various variable factors by predicting working time based on working time during a plurality of periods with different lengths. In addition, by properly grasping work delays in a distribution center, it becomes possible to make appropriate management decisions to reduce delays, such as increasing or decreasing the number of workers or selection of a work, and thus it is expected to be able to suppress increases in costs due to work delays.

The details of at least one implementation of the subject matter disclosed in the present specification are described in the accompanying drawings and the description below. Other features, aspects, and advantages of the disclosed subject matter are apparent from the following disclosure, drawings, and claims.

### BRIEF DESCRIPTION OF DRAWINGS

FIG. 1 is a block diagram illustrating an example of a configuration of an information processing system according to an embodiment of the present invention.

FIG. 2 is a perspective view illustrating an outline of a distribution center according to the embodiment of the present invention.

FIG. 3 is a flowchart illustrating an example of processing performed in the information processing system according to the embodiment of the present invention.

FIG. 4A is a first half of a diagram illustrating an example of a station log according to the embodiment of the present invention.

FIG. 4B is a second half of a diagram illustrating the example of the station log according to the embodiment of the present invention.

FIG. 5 is a diagram illustrating an example of station performance data according to the embodiment of the present invention.

FIG. 6 is a diagram illustrating an example of worker performance data according to the embodiment of the present invention.

FIG. 7A is a diagram illustrating an example of period performance data according to the embodiment of the present invention.

FIG. 7B is a diagram illustrating an outline of calculation of the period performance data according to the embodiment of the present invention.

FIG. 8 is a diagram illustrating an example of a work day characteristic according to the embodiment of the present invention.

FIG. 9 is a diagram illustrating an example of a weighting coefficient according to the embodiment of the present invention.

FIG. 10 is a diagram illustrating an example of work schedule information according to the embodiment of the present invention.

FIG. 11 is a diagram illustrating an example of prediction data according to the embodiment of the present invention.

FIG. 12 is a diagram illustrating an example of device information according to the embodiment of the present invention.

FIG. 13 is a diagram illustrating an example of worker work information according to the embodiment of the present invention.

FIG. 14 is a diagram illustrating an example of a prediction screen according to the embodiment of the present invention.

FIG. 15 is a diagram illustrating an example of order information according to the embodiment of the present invention.

FIG. 16 is a diagram illustrating an example of inventory information according to the embodiment of the present invention.

FIG. 17 is a diagram illustrating an example of shelf information according to the embodiment of the present invention.

FIG. 18 is a diagram illustrating another example of the prediction screen according to the embodiment of the present invention.

### DESCRIPTION OF EMBODIMENTS

Hereinafter, embodiments of the present invention are described based on the accompanying drawings.

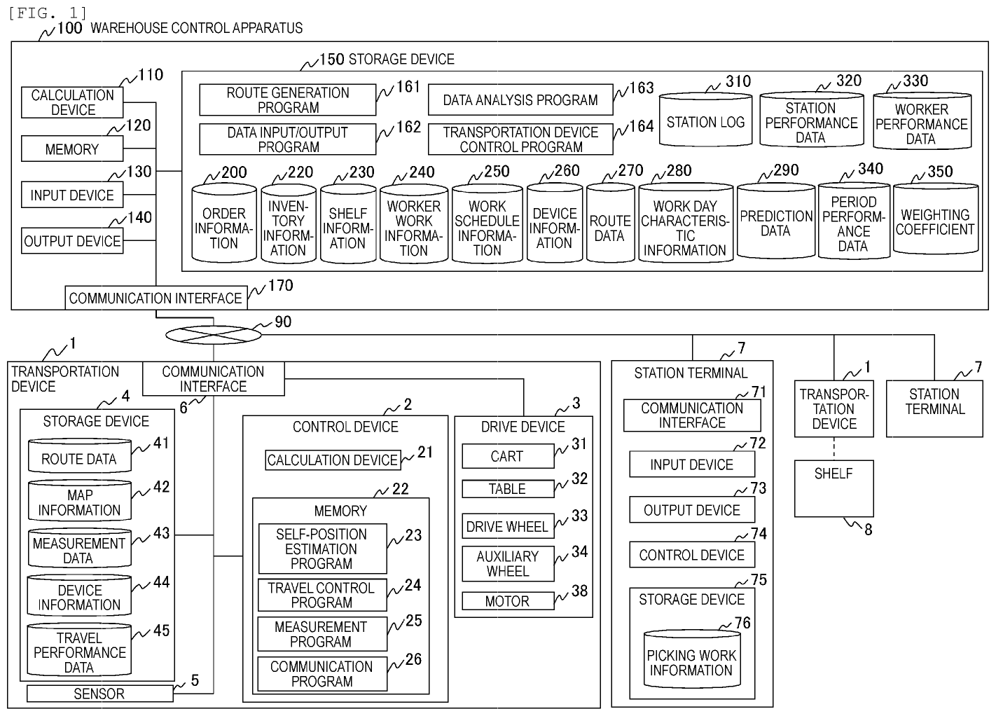

FIG. 1 is a block diagram illustrating an example of a configuration of an information processing system in an embodiment of the present invention. The information processing system of the present embodiment includes a warehouse control apparatus 100, a network 90, and a plurality of transportation devices 1 and a plurality of station terminals 7 connected to the warehouse control apparatus 100 via the network 90.

The present embodiment is an example in which a worker operates the station n terminal 7 set in a warehouse of a distribution center, and the warehouse control apparatus 100 causes the transportation device 1 to transport a shelf 8 (storage portion) to a picking station (or a work station), whereby the worker performs a picking work.

The warehouse control apparatus 100 is a computer including a calculation device 110, a memory 120, an input device 130, an output device 140, a storage device 150, and a communication interface 170. Note that, the warehouse control apparatus 100 is not limited to the configuration illustrated in FIG. 1. The warehouse control apparatus 100 may be one computer or may be configured with a plurality of computers. Also, each device included in the warehouse control apparatus 100 may be arranged in one computer or may be configured with a plurality of devices in a distributed manner. Each program or each item of information in the storage device 150 may be stored in one storage device or may be stored in a plurality of storage devices in a distributed manner.

The storage device 150 includes a nonvolatile storage medium and stores a program to be executed by the calculation device 110 or data to be used by the program. As an example of a program, a route generation program 161, a data input/output program 162, a data analysis program 163 (control unit), a transportation device control program 164 are stored in the storage device 150, and the calculation device 110 loads a required program onto the memory 120 and executes the program.

Also, as an example of the data stored in the storage device 150, order information 200, inventory information 220, shelf information 230, worker work information 240, work schedule information 250, device information 260, route data 270, work day characteristic 280, prediction data 290, a station log 310, station performance data 320, worker performance data 330, period performance data 340, and a weighting coefficient 350 are stored.

The route generation program 161 calculates a route in which the transportation device 1 moves based on preset map information (not illustrated). The route generation program 161 calculates the route in which the transportation device 1 moves, for example, from a position of a product (or a merchandise) to be picked, a position of a destination picking station, and the like.

The transportation device control program 164 instructs the shelf 8 to be transported and the picking station of the transportation destination to the available transportation device 1 based on the route calculated by the route generation program 161, the device information 260, and the like.

The data input/output program 162 receives order information, receives an input from the station terminal 7 operated by the worker, or receives sensor data from the transportation device 1 and accumulates the information, the input, or the data in the station log 310. Also, when receiving the instruction of departure of the transportation device 1 from the station terminal 7, the data input/output program 162 transmits the instruction generated by the transportation device control program 164 to the transportation device 1.

The data analysis program 163 generates the station performance data 320 obtained by recording working time per picking station and the worker performance data 330 obtained by recording working time per worker based on the station log 310, adds up the period performance data 340 as described below, calculates work prediction data per picking station, and stores the data in the prediction data 290.

The data analysis program 163 adds up details of the prediction data 290, generates a prediction screen 51, displays the screen on the output device 140, visualizes a progress status of a work of the picking station that is performed in the warehouse of the distribution center.

The order information 200 stores information of a product to be picked with information of an order for requesting a shipment of the product. The inventory information 220 stores information relating to an inventory of a product such as information of the shelf 8 where the product is arranged, an arrangement position of the product in the shelf 8, a quantity, and the weight. The shelf information 230 stores information such as a position or a weight of the shelf.

The worker work information 240 stores work schedule of the worker and information related to the experience or status of the worker. In addition to the length of service of the worker, the information related to the experience or status of the worker may include information on the height or the condition of the worker and information related to continuous working time of the day. The work schedule information 250 stores information such as a product as a working target per picking station, estimated completion time of the work, and a worker who performs the work. Note that, the work schedule information 250 is data generated in advance, may be input, for example, from the input device 130 of the warehouse control apparatus 100, or may be received from an external computer.

The device information 260 stores identification information, a position, an operation status, and the like of the transportation device 1. The route data 270 stores information of a route in the warehouse per the transportation device 1. The work day characteristic 280 is obtained by attributing work days according to various conditions, and attribution according to conditions such as season, presence or absence of events, weather, disasters, failures in addition to information such as the total amount of warehousing and shipping work is considered. Here, as an example, information about opening of events such as sales held at malls handled by the distribution center, seasonal information, and information about occurrence of disasters or failures are stored.

The station log 310 accumulates works performed at the picking station and logs operated by the transportation device 1. The station performance data 320 extracts data per picking station from the station log 310 and stores time of starting and ending the work, work details, and the like. The worker performance data 330 extracts data per worker from the station log 310 and stores the time of starting and ending of the work, work details, workloads, and the like.

The period performance data 340 stores statistical information on working time extracted per type of work from the station performance data 320 for a plurality of preset periods, per picking station. Note that, in the present embodiment, an example in which average time is employed as the statistical information is provided. The weighting coefficient 350 stores a coefficient used in case of calculating predicted completion time of various works per picking station. Note that, the weighting coefficient 350 is preset information. The weighting coefficient 350 may be a variable value set by the user, and for the setting of the weighting coefficient, a value automatically calculated by using AI based on performance data in the past may also be set.

The prediction data 290 stores time when a job is complete per picking station which is calculated by the data analysis program 163, by using the station performance data 320, the worker performance data 330, and the weighting coefficient 350.

The input device 130 is configured with a keyboard, a mouse, a touch panel, or the like. The output device 140 is configured with a display or the like. The communication interface 170 performs communication with the transportation device 1 or another computer via the network 90, wirelessly or the like.

The transportation device 1 is an autonomous moving body that can automatically transport the shelf 8 loaded with a product according to the instruction from the warehouse control apparatus 100. The transportation device 1 is an autonomous transportation device including a control device 2, the storage device 4, a drive device 3, a sensor 5, and a communication interface 6. The sensor 5 includes, for example, a vibration sensor (acceleration sensor) and an image sensor.

The control device 2 includes a calculation device 21 and a memory 22. A self-position estimation program 23, a travel control program 24, a measurement program 25, and a communication program 26 are loaded onto the memory 22 and are executed by the calculation device 21. The calculation device 21 is configured with a microcomputer or a processor.

The self-position estimation program 23 calculates a position of the transportation device 1 based on image data (image or moving image data) acquired from the image sensor. Note that, in the present embodiment, an example in which a marker indicating a position is displayed on the floor surface of the warehouse in advance is provided. The self-position estimation program 23 calculates the position of the transportation device 1 from the marker read by the image sensor. The marker arranged on the floor surface is information readable by the sensor 5 of the transportation device 1 and is, for example, a QR code (registered trademark). Note that, a configuration in which the image data acquired from the image sensor or the like is transmitted to the warehouse control apparatus 100, and the position of the transportation device 1 is estimated by the warehouse control apparatus 100 may be adopted. The marker may also be referred to as a mark or a reference marker.

For example, the floor of the warehouse is managed in a plurality of sections, and each of the plurality of sections is indicated with a marker related to the position of the section. The transportation device 1 travels on the floor, reads the marker indicated on the floor of the corresponding section when passing through each section, and acquires the information related to the position of the corresponding section. The marker may include information for specifying the position of the section. For example, the information may be position information of the section or may be information associated with the position information of the section (for example, the identification information of the section).

The travel control program 24 controls the drive device 3 based on the current position of the transportation device 1 and the route data 270 received from the warehouse control apparatus 100. Note that the warehouse control apparatus 100 transmits, to the transportation device 1, the route data 270 per transportation device 1 that is generated by the route generation program 161, and the transportation device 1 stores the route data 270 in the route data 41 of the storage device 4.

The measurement program 25 acquires sensor data acquired from the sensor 5, the travel speed and acceleration acquired from the travel control program 24, and the position of the transportation device 1 calculated by the self-position estimation program 23 and transmits the data, the travel speed and acceleration, and the position to the warehouse control apparatus 100. The sensor data includes vibration data from a vibration sensor and image data of the floor surface from the image sensor. Also, a timing when the measurement program 25 transmits the sensor data to the warehouse control apparatus 100 may be a predetermined timing, or the transmission may be performed at a predetermined cycle (for example, per 24 hours) or the like.

The storage device 4 is configured with a nonvolatile storage medium and stores programs and data to be used by the programs. Examples of the data include the route data 41, map information 42, measurement data 43, device information 44, travel performance data 45, and floor information 46.

The route data 41 stores the route data received from the warehouse control apparatus 100. The map information 42 stores the map information received from the warehouse control apparatus 100. The measurement data 43 stores the sensor data acquired by the sensor 5 or data acquired or calculated by the programs.

The device information 44 stores the identifier (device ID) of the transportation device 1, the status of the device, information regarding the presence or absence of loading of the shelf, the position of the device, the remaining battery capacity, the cumulative travel distance, the cumulative number of accelerations, and the like. For example, the device information 44 may be information equivalent to the information regarding the transportation device 1 in the device information 260. The travel performance data 45 stores a history of a route in which the transportation device 1 moves, the status (vibration) of the floor surface per area, the mode of movement, and the like.

The drive device 3 includes a cart 31, a drive wheel 33, a table 32, an auxiliary wheel (caster) 34, motors 38 as power sources for driving the drive wheel 33 or the table 32, and batteries (not illustrated) for supplying electric power to the motors 38. The motors 38 for driving the drive wheel 33 and the table 32 can be configured with motors independent from each other.

The drive device 3 moves under the shelf 8 and lifts the shelf 8 by raising the table 32. Also, the drive device 3 travels to an instructed position in a state of lifting the shelf 8, descends the table 32, and lays down the shelf 8 on the floor surface.

The calculation device 21 executes the processing according to the program of each functional unit and operates as a functional unit of providing a predetermined function. For example, the calculation device 21 executes the processing according to the travel control program 24 and functions as a travel control unit. The same is applied to the other programs. Further, the calculation device 21 operates as a functional unit of providing respective functions of a plurality of pieces of processing executed by the programs.

The station terminals 7 are installed per picking station at which the worker performs a work. The station terminal 7 displays the work schedule information 250 transmitted from the warehouse control apparatus 100, presents work details to the worker, receives an input from the worker, transmits the input to the warehouse control apparatus 100.

The station terminal 7 includes a communication interface 71, an input device 72, an output device 73, a control device 74, and a storage device 75. The communication interface 71 performs communication with the warehouse control apparatus 100 via the network 90. The input device 72 is configured with a touch panel, a keyboard, and the like. The output device 73 is configured with a display or a speaker. The control device 74 is configured with a microcomputer or the like and executes a predetermined program. The storage device 4 stores a program or data.

The station terminal 7 receives scheduled work to be performed at the corresponding picking station from the warehouse control apparatus 100 and stores the scheduled work in picking work information 76 of the storage device 75. The station terminal 7 outputs an instruction according to the work status of the worker from the picking work information 76 to the output device 73.

The worker operates the station terminal 7 when the work starts or after a predetermined work is completed and acquires the instruction of the work and the like. The input device 72 of the station terminal 7 includes a picking start button, a picking completion button, an assortment start button, an assortment completion button, a departure button, a stop button, a restoration button, and the like.

For example, the worker presses the picking start button, acquires the designated product from the shelf 8, and conveys the product to the predetermined position. When picking of the designated product is completed, the worker presses picking completion button. Next, the worker presses the assortment start button and then sorts and packs the picked products. When the designated sorting and packing are completed, the worker presses the assortment completion button. When beginning the next work, the worker presses the departure button to move the transportation device 1 to the warehouse control apparatus 100 and moves the shelf 8 from which the picking is to be performed next to the picking station.

When each button is operated, the control device 74 transmits details of the operation that is received by the input device 72 to the warehouse control apparatus 100. When receiving the details of the operation from the station terminal 7, the warehouse control apparatus 100 accumulates received details to the station log 310 described below.

### <Configuration of Distribution Center>

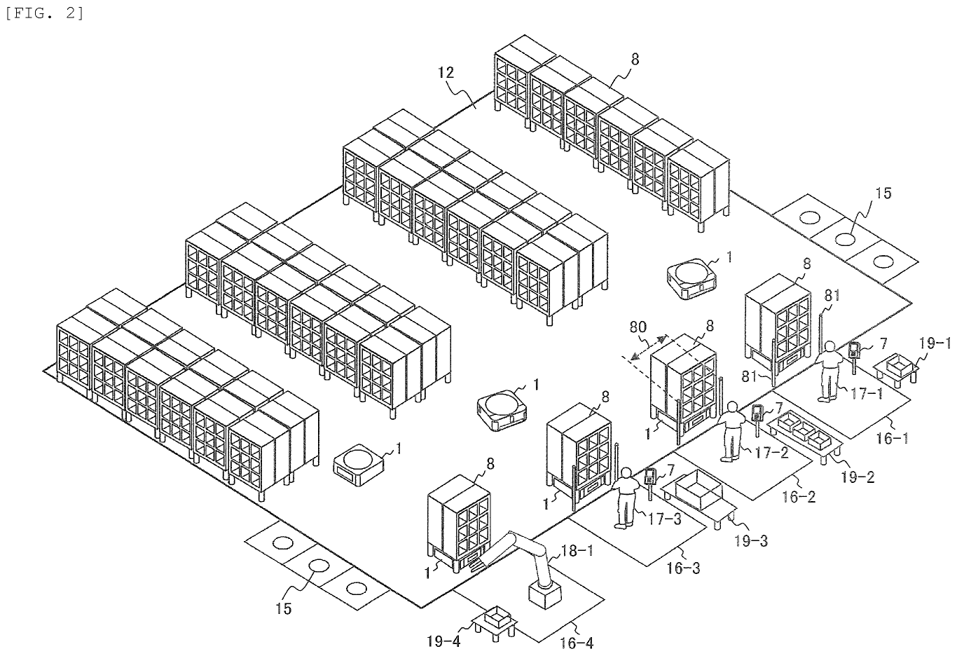

FIG. 2 is a perspective view illustrating an example of a layout of the warehouse of the distribution center. The distribution center includes a storage space 12. The plurality of shelves 8 are arranged in a grid pattern in the vertical and horizontal directions in the storage space 12. The shelves 8 form an “island” including 2×6 or 1×6 shelves 8.

The plurality of transportation devices 1 are arranged in the storage space 12. The transportation device 1 enters below the shelf 8 and lifts and moves the shelf 8. A plurality of chargers 15 for charging the transportation devices 1 are arranged at predetermined locations around the storage space 12.

A plurality of picking stations 16-1 to 16-4 are arranged at predetermined positions on the outer edge of the storage space 12. Workers 17-1 to 17-3 perform warehousing jobs and shipping jobs of the product in the picking stations 16-1 to 16-3, and a work robot 18-1 performs warehousing works and shipping jobs of products in the picking station 16-4.

Note that, in the following description, if picking stations are not individually specified, the reference numeral “16” is used with the part after “-” omitted. The same is applied to reference numerals of the other components.

Safety light curtains 81 and 81 for detecting intrusion of a worker are installed in the picking station 16 connected to the storage space 12. The shelf 8 is arranged between the safety light curtains 81 and 81 and becomes a frontage 80 where the picking work is performed.

Note that, when the shelf 8 is arranged at the frontage 80 by the transportation device 1, the safety light curtains 81 and 81 are turned off, and the picking work by the worker 17 can be performed. Meanwhile, when the picking work is completed and the transportation device 1 moves the shelf 8 from the frontage 80, the safety light curtains 81 and 81 are turned on and outputs an alarm and the like in a case where the worker 17 or the like intrudes from the frontage 80.

The station terminal 7 is arranged near the frontage 80 in the picking station 16 where the worker 17 performs a work. Also, workspaces 19-1 to 19-4 for sorting or packing are installed at a predetermined position near the picking station 16.

The sizes of the workspaces 19 or the sizes of storage portions such as boxes for sorting or packing are different from each other per picking station 16, and the differences become factors that affect the workability of the workers 17.

Also, the difference in positions of the picking stations 16-1 to 16-3 in the warehouse becomes a factor that affects the utilization rate of the worker 17. For example, all of the environments of the picking stations 16 are not equal, and the utilization rate of the picking station 16 near the rest room is high, while the utilization rate of the picking station 16 far from the rest room tends to decrease by the walking distance.

Also, working time may be affected by a factor of a relative relationship between the position of the picking station and the storage position of a product that is a warehousing and shipping target. For example, it is considered that the utilization rate increases in the picking station close to the position where many products of which warehousing and shipping frequency is relatively high are stored. Also, in another example, in a picking station close to the position where heavy and bulky products are stored, the utilization rate may be high, and the workload may be relatively high. In this manner, there are variations in work details, workload, working time per picking station. Also, the variations are not constant and may be changed according to the change in the season or trends or the change in the storage position of the product.

In the present embodiment, examples of the work performed by the worker 17 in the picking station 16 include a picking work, an assortment work, a departure work, and a waiting work for each of the shipping job and the warehousing job. Note that, the waiting work herein refers to a case where a predetermined work is not performed, and the picking station 16 is in a waiting status. Therefore, as described above, the waiting work may be included in the shipping job or the warehousing job or may be treated in the same way as the shipping job and the warehousing job, like setting a status in which a work related to the shipping job and the warehousing job is not performed, as a waiting status.

The shipping job is configured with a work of taking out products stored on the shelf 8 according to a destination, classifying the products per sorting destination, and packing the products in a storage portion per sorting destination. The warehousing job is a work of classifying products arriving at the warehouse per shelf 8 as the storage destination and arranging the classified products at predetermined positions of the shelves 8. Note that, in the present embodiment, works of the shipping job and works of the warehousing job are defined as below.

The picking work of the shipping job is a work of taking out the designated product by the worker 17 from the shelf 8 arrived at the frontage 80 and moving the product to the workspace 19. Note that, designation of the product can be displayed on the output device 73 of the station terminal 7.

The assortment work of the shipping job is a work of storing the product taken out to the workspace 19 in a box (transportation member) corresponding to the destination and packing the corresponding box. Note that, the designation of the destination of the product can be displayed on the output device 73 of the station terminal 7.

The departure work of the shipping job is a work of completing the picking work of the shelf 8 that is arranged at the frontage 80, operating the station terminal 7, and requesting the next shelf 8. The warehouse control apparatus 100 transmits the instruction of moving the shelf 8 of the frontage 80 to the transportation device 1 and instructs the other transportation device 1 to move the next shelf 8 to the frontage 80.

The waiting work is a work of waiting for an instruction related to the next work, such as waiting for assignment of a work to the picking station 16 in both of the shipping job and the warehousing job. Note that, the waiting work herein refers to a case where a predetermined work is not performed, and the picking station 16 is in a waiting status.

The picking work of the warehousing job is a work of taking out an instructed product among products arrived at the frontage 80 from a truck or pallet and moving the instructed product to the workspace 19. Note that, as in the shipping job, the designation of the product can be displayed on the output device 73 of the station terminal 7.

The assortment work of the warehousing job is a work of storing a product taken out to the workspace 19 in the shelf 8 corresponding to the storage destination. Note that the designation of the shelf 8 that stores the product can be displayed on the output device 73 of the station terminal 7.

The departure work of the warehousing job is a work of completing the assortment work of the shelf 8 arranged at the frontage 80, operating the station terminal 7, and requesting the next shelf 8.

### <Outline of Processing>

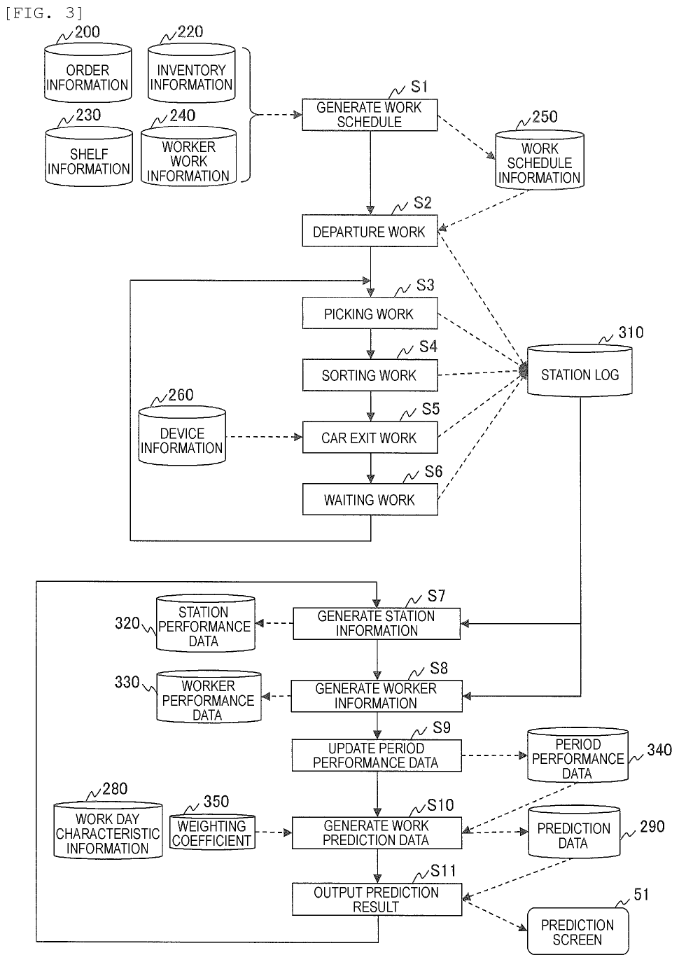

FIG. 3 is a flowchart illustrating an example of processing executed in the information processing system of the distribution center. First, the work schedule information 250 is generated from the inventory information 220, the shelf information 230, and the worker work information 240 based on the order information 200 (S1). This processing may be generated from the input device 72 or may be generated by an external computer and acquired by the warehouse control apparatus 100.

As described below, the work schedule information 250 includes the picking station 16 where the work is to be performed, assignment of the worker 17, information on a product as a working target and the shelf 8, and time when the work is to be completed.

When the work starts, the worker 17 performs the departure work, operates the departure button of the station terminal 7, and moves the first shelf 8 to the picking station 16 (S2). The worker 17 starts the picking work after pressing the picking start button of the station terminal 7. The information of the product as the picking target is displayed on the output device 73 of the station terminal 7.

The control device 74 of the station terminal 7 notifies the warehouse control apparatus 100 of the start of the picking work. The warehouse control apparatus 100 adds a time stamp to the information of the picking station 16 or the workers 17 and generates the log information of the picking start in the station log 310 (S3).

When the picking work is completed, the worker 17 presses the assortment start button of the station terminal 7 and then sorts the products for the destination and the storage portion displayed on the output device 73 of the station terminal 7 to pack the products (S4).

The control device 74 of the station terminal 7 notifies the warehouse control apparatus 100 of the start of the assortment work. The warehouse control apparatus 100 adds a time stamp to the information of the picking station 16 or the workers 17 to generate the log information of the completion of the picking work and the start of the assortment work in the station log 310.

When the assortment work is completed, the worker 17 presses the departure button of the station terminal 7 and requests the next shelf 8 (S5).

The control device 74 of the station terminal 7 notifies the warehouse control apparatus 100 of the completion of the assortment work. The warehouse control apparatus 100 adds a time stamp to the information of the picking station 16 or the worker 17 and generates the log information on the completion of the assortment work and the start of the departure work in the station log 310. Note that when the shelf 8 that is requested in the departure work arrives at the designated picking station 16, the warehouse control apparatus 100 generates the log information of the completion of the departure work in the station log 310.

In the above, the work in steps S3 to S5 is completed, the worker 17 enters the waiting work. The worker 17 operates each station terminal 7 at the time of the start and the end of the waiting work and notifies the warehouse control apparatus 100 of the start and the end of the waiting work. The warehouse control apparatus 100 receives the notification, generates the log information of the start and the end of the waiting work, and accumulates the log information in the station log 310. Note that, the waiting work herein indicates the case where the picking station 16 is in the waiting status without performing a predetermined work. Here, it is described that the waiting work is included in the shipping job or the warehousing job but may be treated in the same way as the shipping job and the warehousing job, like setting a status in which a work related to the shipping job and the warehousing job is not performed, as a waiting status.

When the waiting work ends, the worker 17 returns to step S3 and starts the next shipping job or the next warehousing job. Note that, when the work ends, or a break is acquired, the worker 17 operates the predetermined button of the station terminal 7 and notifies the warehouse control apparatus 100 of the status of the worker 17. The warehouse control apparatus 100 that receives the notification generates the log information according to the notification detail and accumulates the log information in the station log 310.

The warehouse control apparatus 100 executes processing of calculating the prediction data 290 of the work completion asynchronously to the processing in steps S2 to S6, in steps S7 to S11. The calculation processing of the prediction data is executed by the data analysis program 163 of the warehouse control apparatus 100. The data analysis program 163 reads the station log 310 at a predetermined cycle and estimates the job completion time per picking station 16.

First, the warehouse control apparatus 100 reads the unprocessed log information from the station log 310, acquires the start time and the end time of the work per picking station 16, generates the information related to the progress status of the job, and stores the information in the station performance data 320 (S7). Note that, as described below, the information of the worker 17 who is in charge of the job or the details of the job can be added to the station performance data 320.

Next, the warehouse control apparatus 100 reads the unprocessed log information from the station log 310, acquires the start time and the end time of the work per the worker 17, generates the information related to the progress status of the work, and stores the information in the worker performance data 330 (S8). Note that, as described below, details of the work or the load of the worker 17 can be added to the worker performance data 330.

The load to the worker 17 can be preset according to the weight of the product to be handled, the height difference of the worker 17, or the like. There is a type of the weight of the product that changes according to the season. For example, in the case of clothing, winter items tend to be heavier, and summer items tend to be lighter. Even in case of the same type of clothing, the working time for handling clothing of winter items tends to increase. Therefore, by setting the load according to the weight even in case of the same type of items, it is possible to improve the prediction accuracy of work completion.

Note that, when the worker 17 is short in height, in case of the picking work, the time required to take out the product stored at the top portion of the shelf 8 tends to increase, and thus, it is possible to improve the prediction accuracy of the work completion by setting the load according to the height difference of the worker 17.

Next, the warehouse control apparatus 100 calculates the average time per work (or per number of rows) per picking station 16 as described below, from the station performance data 320 and the worker performance data 330 and updates s the period performance data 340 (S9). With respect to the average time per work, the warehouse control apparatus 100 according to the present embodiment calculates the average time of a plurality of periods with different lengths per work, as described below.

Here, the warehouse control apparatus 100 calculates the predicted completion time per job and per work, per picking station 16 as described below, by using the period performance data 340 updated in step S9, the weighting coefficient 350, and the work day characteristic 280, and generates the prediction data 290 (S10).

The warehouse control apparatus 100 can consider short-term factors, medium-term factors, and long-term factors by predicting the completion time of the work and the job based on the average time of the plurality of periods with different lengths to generate the highly accurate prediction data 290. Note that, the weighting coefficient 350 is preset per period.

Also, the warehouse control apparatus 100 can consider a case where a deviation occurs in the product to be handled due to the occurrence of an event on each work day by referring to the work day characteristic 280 to predict the completion time of the work. For example, when a known event or failure occurs on the day or the previous day of the work, the completion time of the work is predicted by referring to the station performance data 320 or the worker performance data 330 on a day when a similar event or failure occurs, and the accuracy can be improved.

Also, the prediction data 290 is calculated per picking station 16 to consider the difference of the working time caused by the difference of the environment per picking station 16, and the accuracy of the prediction data 290 can be improved. Here, the difference of the environment per picking station 16 include variations in work details, workload, and working time by the position of the picking station, changes in seasons and trends to the variation, and the effects of the changes in storage positions of the product.

The warehouse control apparatus 100 generates the prediction screen 51 indicating the progress status of the entire warehouse based on predicted completion time of the work for the entire warehouse of the distribution center or per picking station 16 from the generated prediction data 290 and displays the prediction screen on the output device 140.

The manager of the distribution center or the warehouse or the like can grasp the progress status of the work for the entire warehouse or per picking station 16 by referring to the prediction screen 51 of the output device 140. Accordingly, it is possible to predict the working time by considering the various variable factors that affect the working time in the distribution center.

Hereinafter, the data used in each piece of processing is described below.

### <Data>

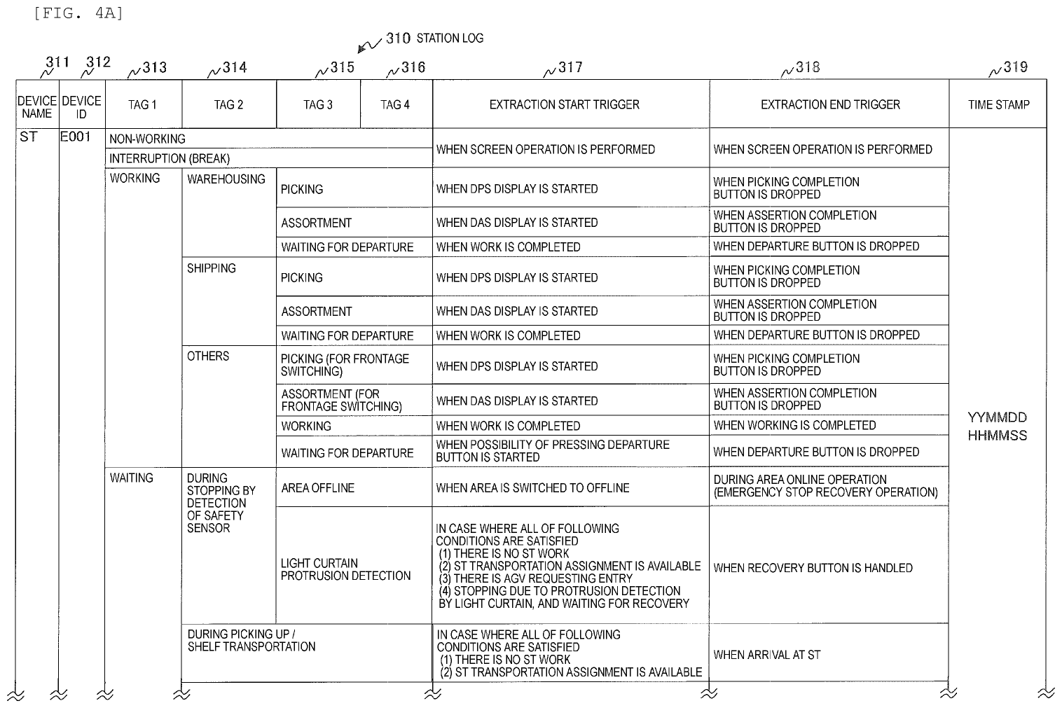

FIGS. 4A and 4B are diagrams illustrating an example of the station log 310. The station log 310 is generated by the warehouse control apparatus 100 in steps S2 to S6 of FIG. 3.

The station log 310 includes a device name 311, a device ID 312, a tag 1 (313), a tag 2 (314), a tag 3 (315), a tag 4 (316), an extraction start trigger 317, an extraction end trigger 318, and a time stamp 319 in one record.

The device name 311 stores the name of a device that acquires the log or the like. The device name 311 stores a code of “ST” when the device that acquires the log is the station terminal 7. The device ID 312 stores the identifier of the picking station 16, the station terminal 7, or the like. In the illustrated example, “E001” is an identifier of the picking station 16 (or the station terminal 7).

The tag 1 (313) stores statuses of working, waiting, and other jobs. The tag 2 (314) stores statuses of jobs such as warehousing, shipping, and others. The tag 3 (315) and the tag 4 (316) store details of works such as picking, assortment, and departure.

The extraction start trigger 317 defines a trigger to extract the start time of the log information defined by the tag 1 (313) to the tag 4 (316). The extraction end trigger 318 defines a trigger to extract the end time of the log information defined by the tag 1 (313) to the tag 4 (316).

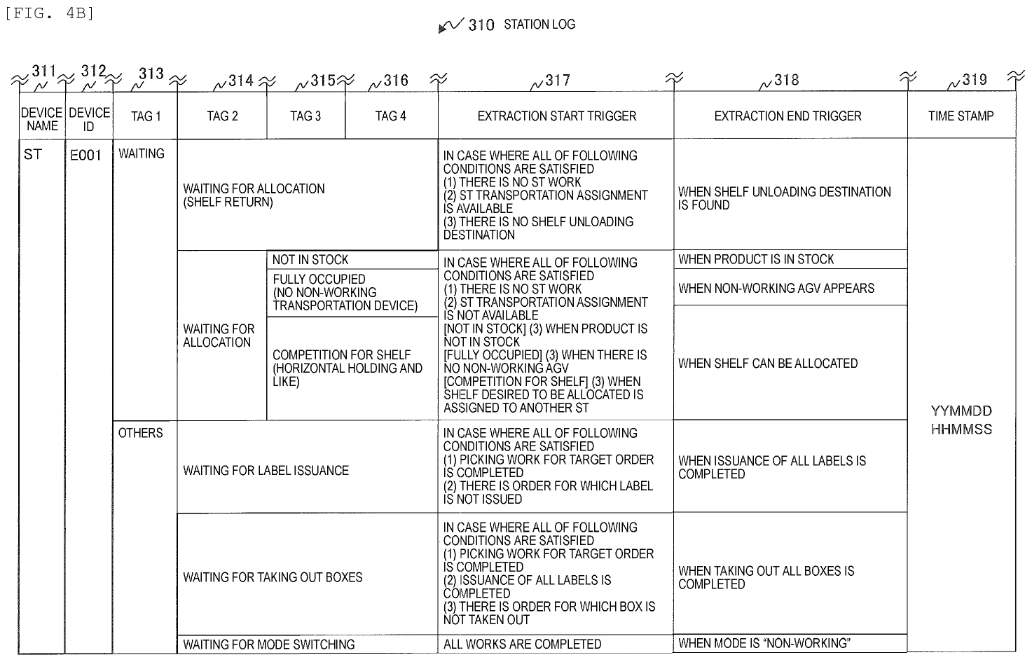

FIG. 5 is a diagram illustrating an example of the station performance data 320. The station performance data 320 is generated by the warehouse control apparatus 100 in step S7 of FIG. 3.

The station performance data 320 includes a station ID 321, a status 322, a worker ID 323, start/end 324, time 325, a processing ID 326, the number of rows 327, a shelf ID 328, and a product ID×quantity 329 in one record.

The station ID 321 stores the identifier of the picking stations 16. The status 322 stores the details of the job. The worker ID 323 stores the identifier of the worker 17 who is in charge of the job. Note that, the worker ID 323 can store the identifier the plurality of workers 17. The start/end 324 stores whether the corresponding record is either of the job start or the job end. The time 325 stores the date and time of the start or the end.

The processing ID 326 stores the identifier of the job set in the work schedule information 250 described below. The number of rows 327 stores the types (the number of records) of the product designated by the processing ID 326.

The shelf ID 328 stores the identifier of the shelf 8 on which the job is performed. The product ID×quantity 329 stores the identifier and the quantity of the product for which the job is performed to the designated shelf 8.

Note that, in the illustrated example, the status 322 includes a case where the picking station 16 is in the waiting status without performing a predetermined work. In FIG. 5, the waiting (waiting work) is treated in the same way as the shipping job or the warehousing job but may be included in the shipping job or the warehousing job as described above.

In the illustrated example, the information as follows is stored.

From 10:00:00 to 10:10:00 on Nov. 1, 2018, the worker 17 is in the “waiting (waiting for allocation)” status at the station ID 321=“E001”. The “waiting for allocation” means that the worker waits for designation as the picking station 16 to perform a specific work.

From 10:10:00 to 10:12:00, a worker ID=C001 is in the “waiting (picking up or transportation to shelf)” status at the station ID=“E001”. The “picking up” means that the designated transportation device 1 travels to the position of the shelf 8 that stores the target product for taking the shelf, while the worker waits. Also, the “shelf transportation” means that the corresponding transportation device 1 transports the shelf 8 that stores the target product in the lift status, while the worker ID=C001 waits.

From 10:12:00 to 10:32:00, the worker ID=C001 performs the “warehousing job” at the station ID=E001. The number of rows to be processed in the work schedule information 250 related to this job is “1”. The worker ID=C001 of the station ID=“E001” performs the work of warehousing 20 products D031 with respect to a shelf ID=S011 based on the work schedule information 250.

From 10:32:00 to 10:35:00, the worker ID=C001 is in the “waiting (waiting for allocation)” status at the station ID=“E001”.

From 10:35:00 to 10:36:00, the worker ID=C001 is in a “waiting (picking up or shelf transportation)” status at the station ID=“E001”.

From 10:36:00 to 11:10:00, the worker ID=C001 performs the shipping job at the station ID=“E001”. The number of rows to be processed in the work schedule information 250 related to this job is “1”. The work of shipping at least 30 products D021 from at least a shelf S049 is performed based on the work schedule information 250 at the station ID=“E001”.

From 10:40:00 to 10:41:00, the worker ID=C001 performs “waiting (detection by safety sensor)”, at the station ID=E001. The “detection by safety sensor” means, for example, that the safety light curtain 81 of the picking station 16 is blocked. That is, during this time, the job is interrupted at the station ID=“E001”.

From 11:10:00 to 11:15:00, the worker ID=C001 is in a “waiting (waiting for allocation)” status at the station ID=“E001”.

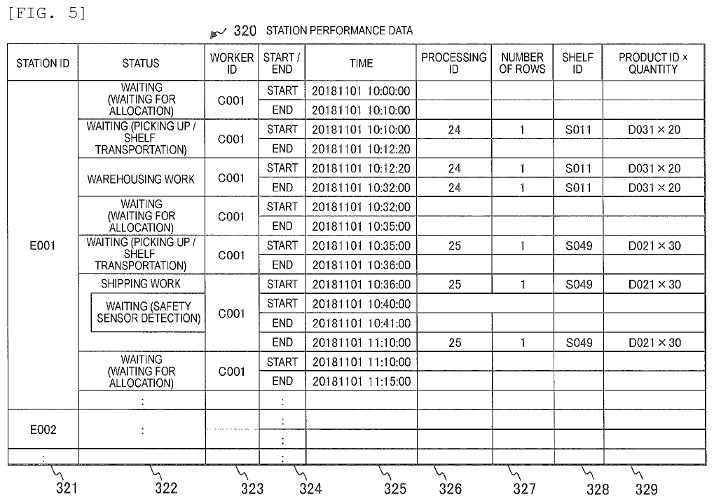

FIG. 6 is a diagram illustrating an example of the worker performance data 330. The worker performance data 330 is generated by the warehouse control apparatus 100 in step S8 of FIG. 3.

The worker performance data 330 includes a worker ID 331, a status 332, start/end 333, time 334, a processing ID 335, a product ID×quantity 336, and a load 337 in one record.

The worker ID 331 stores the identifier of the worker 17. The status 332 stores the details of the work. The start/end 333 stores whether the corresponding record is either of the start or the end of the work. The time 334 stores the date and time of the start or the end.

The processing ID 335 stores the identifier of the job set in the work schedule information 250 described below. The product ID×quantity 336 stores the identifier and the quantity of the product for which the work is performed. The load 337 stores a ratio of the load added to the worker 17. The load 337 may be determined based on the characteristic per worker 17, the size or weight of the product for which the work is performed, or the like.

The warehouse control apparatus 100 calculates working time of the status 322 per processing ID 335 of the worker 17 and sets the working time as the working time of the job stored in the status 322 of the station performance data 320 corresponding to the processing ID 335 and the worker ID 331 of the worker performance data 330.

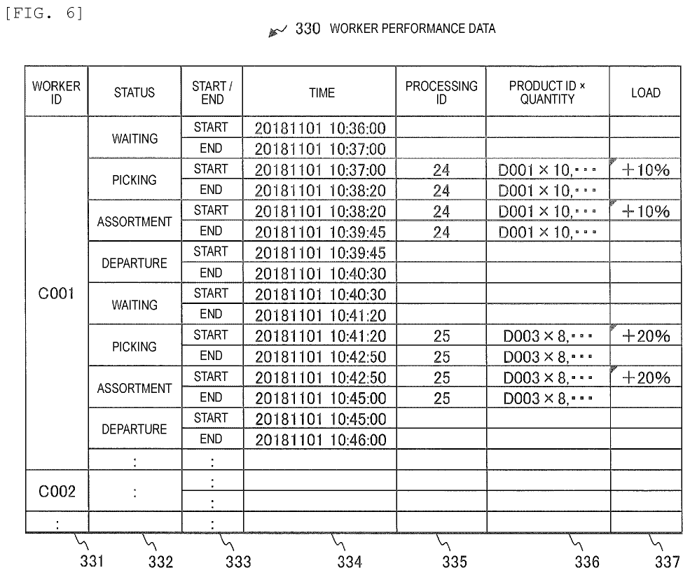

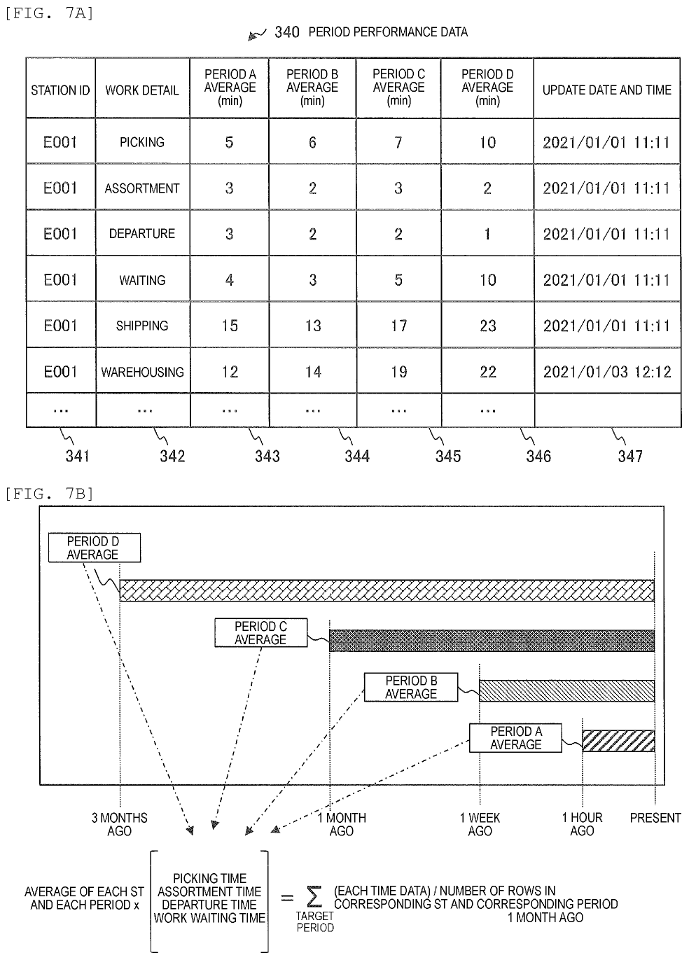

FIG. 7A is a diagram illustrating an example of the period performance data 340. The period performance data 340 is generated and updated by the warehouse control apparatus 100 in step S9 of FIG. 3.

The period performance data 340 includes a station ID 341, a work detail 342, a period A average 343, a period B average 344, a period C average 345, a period D average 346, and update date and time 347 in one record.

The station ID 341 stores the identifier of the picking station 16. The work detail 342 stores details of the work performed at the corresponding picking station 16. The period A average 343 to the period D average 346 store the average time of each work in the plurality of periods with different lengths.

FIG. 7B illustrates lengths of the periods A to D of the period performance data 340. The lengths of the periods A to D are preset and can be appropriately set according to the operational status of the distribution center or the warehouse. The illustrated example is an example in which the period A is the past one hour, the period B is the past one week, the period C is the past one month, and the period D is the past three months.

For example, as shown in Equation (1) of FIG. 7B, the period A average 343 of FIG. 7A stores the average value of the working time from the work start to the work end that is calculated for the respective work details 342 from the worker performance data 330 for the past one hour from the present.

In the same manner, the period B average 344 stores the average value of the working time for the respective work details 342 from the worker performance data 330 for the past one week from the present, the period C average 345 stores the average value of the working time for the respective work details 342 from the worker performance data 330 for the past one month from the present, and the period D average 346 stores the average value of the working time for the respective work details 342 from the worker performance data 330 for the past three months from the present. Note that, the period performance data 340 is data storing the average time for each work per picking station 16.

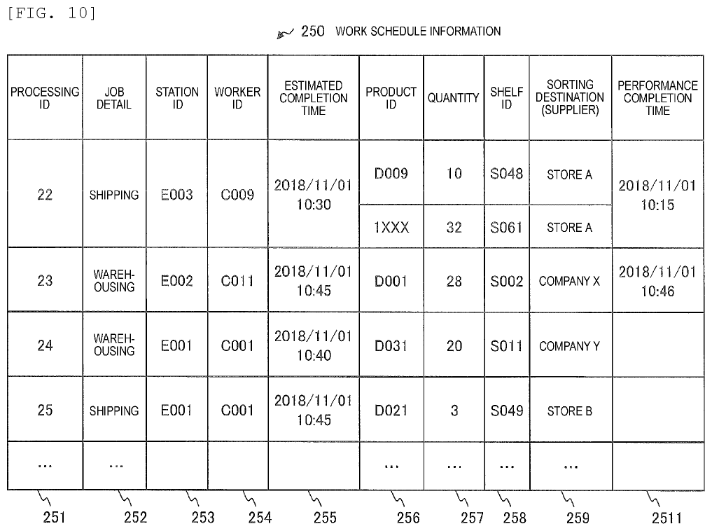

Note that, the average time of the work of each period is a value obtained by dividing the sum of the working time performed in each picking station 16 by the number of rows of each work. Here, the number of rows of each work is the value obtained by counting each record of the work schedule information 250 as one row as described below. For example, in FIG. 10, the product ID=“D009” and “1XXX” are counted as different rows.

Also, the shipping job and the warehousing job in the drawing may be stored in the period performance data 340 per the picking station 16 (ST in the drawing) as the sum of the average time of the picking work, the assortment work, the shipping work, and the waiting work.

Also, a short period of the period A extracts the performance depending on the worker 17, and long periods of the periods B to D can extract the performance per picking station 16 by the plurality of workers 17, without being limited to the specific worker 17.

FIG. 8 is a diagram illustrating an example of the work day characteristic 280. The work day characteristic 280 is information preset for correcting the predicted completion time. The work day characteristic 280 includes a date 281, an event 282, a season 283, and a correction coefficient 284 in one record.

The event 282 stores details of event occurring on the date 281 (or event estimated to occur). The season 283 stores the season of the date 281. The correction coefficient 284 stores the coefficient for correcting the predicted completion time according to the event 282 or the season 283. The correction coefficient stores the preset value according to the details of the event 282 or the season 283.

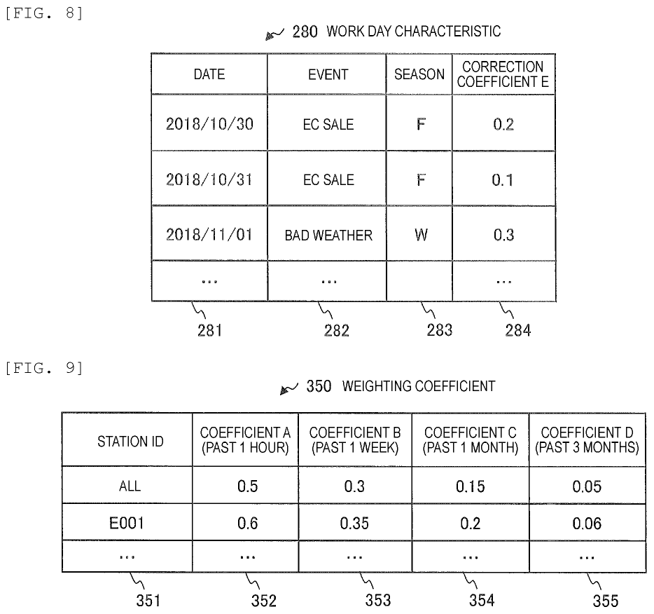

FIG. 9 is a diagram illustrating an example of the weighting coefficient 350. The weighting coefficient 350 is information for presetting the weighting to be given to each of the periods A to D, when the predicted completion time is calculated.

The weighting coefficient 350 includes a station ID 351, and coefficient A 352 to coefficient D 355 in one record.

The station ID 351 stores the identifier of the picking station 16. The coefficient A 352 to the coefficient D 355 are weighting coefficients corresponding to the periods A to D of the period performance data 340 and are set per the picking station 16. Note that, the weighting coefficients A to D of the periods A to D may be one value of the entire warehouse (or distribution center) like the station ID=“entire” in the drawing.

FIG. 10 is a diagram illustrating an example of the work schedule information 250. The work schedule information 250 is information set in step S1 of FIG. 3.

The work schedule information 250 includes a processing ID 251, a job detail 252, the station ID 253, a worker ID 254, estimated completion time 255, a product ID 256, a quantity 257, a shelf ID 258, a sorting destination 259, and performance completion time 2511 in one record.

The processing ID 251 stores a unique identifier in the warehouse. The job detail 252 stores details of the job such as shipping or warehousing. The station ID 253 stores an identifier of the picking station 16 where the job is performed.

The worker ID 254 stores the identifier of the worker 17 assigned to the picking station 16. The estimated completion time 255 stores target completion date and time of the corresponding job. The product ID 256 stores the identifier of the product handled in the corresponding job. The quantity 257 stores the quantity of the products.

The shelf ID 258 stores the identifier of the shelf 8 where the product is stored. Note that, the relationship between the product and the shelf 8 is set in the inventory information 220 described below. The sorting destination 259 stores the destination for delivering the product. Note that, when the job is warehousing, the supplier of the product can be stored. The performance completion time 2511 stores date and time when the job is actually completed.

In the work schedule information 250, one record of the product ID 256 is handled as the number of rows=1. For example, since the processing ID 251=“22” has two records of product IDs=“D009” and “1XXX”, the corresponding processing ID 251 is handled as the number of rows=2. That is, in the present embodiment, an example in which the number of rows corresponds to the type of the product regardless of the quantity 257 is provided. In the slip number of the order information 200 and the processing ID of the work schedule information 250, the corresponding data or the same data may be used.

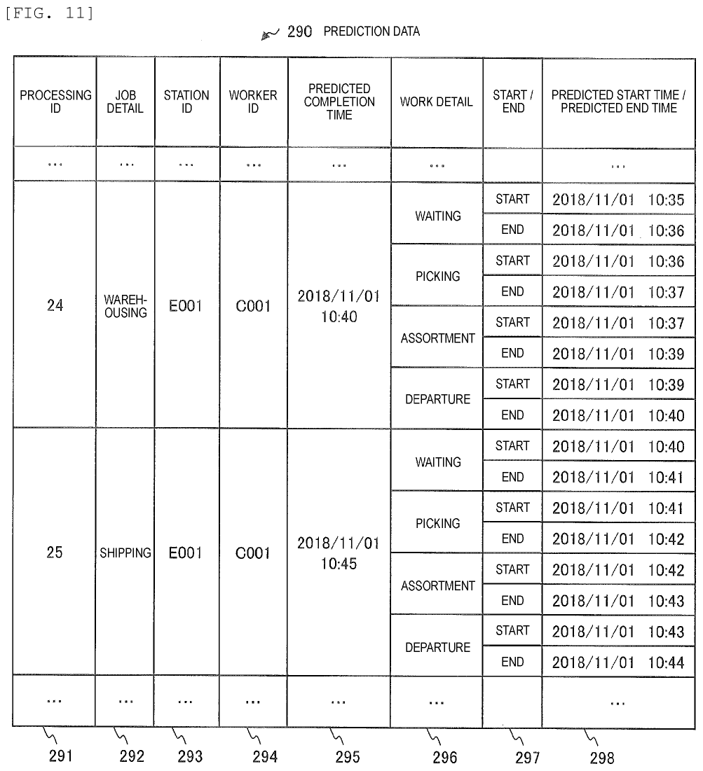

FIG. 11 is a diagram illustrating an example of the prediction data 290. The prediction data 290 is information generated in step S10 of FIG. 3. The prediction data 290 includes a processing ID 291, a job detail 292, a station ID 293, a worker ID 294, predicted completion time 295, a work detail 296, start/end 297, and predicted start time/predicted end time 298 in the one record.

The processing ID 291 stores an identifier corresponding to the processing ID 251 of the work schedule information 250. The job detail 292 stores the job corresponding to the job detail 252 of the work schedule information 250. The station ID 293 stores the identifier of the picking station 16 corresponding to the station ID 253 of the work schedule information 250. The worker ID 294 stores the identifier corresponding to the worker ID 254 of the work schedule information 250.

The predicted completion time 295 stores date and time of the job completion that is predicted by the warehouse control apparatus 100. The work detail 296 stores the item of the work included in the job (the waiting work, the picking work, the assortment work, and the departure work). The start/end 297 stores the label of the start and the end of each work. The predicted start time/predicted end time 298 stores predicted start time or predicted end time of the work that is predicted by the warehouse control apparatus 100.

Note that, in the present embodiment, the predicted start time is set as the predicted end time of the immediately preceding work, and the predicted start time of the first work at the start of the job can be time when the warehouse control apparatus 100 receives the information of the work start.

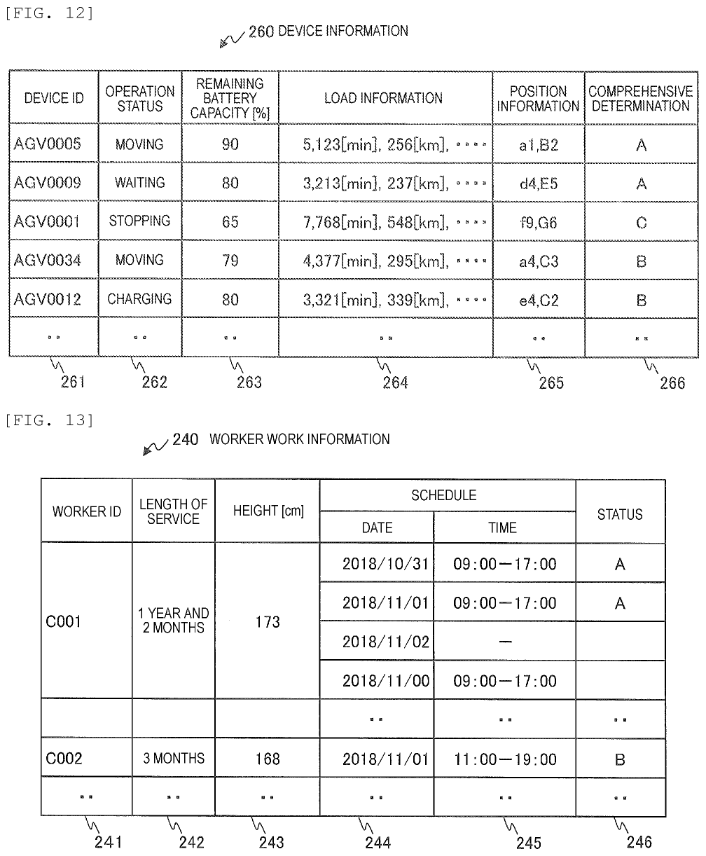

FIG. 12 is a diagram illustrating an example of the device information 260. The device information 260 is information acquired by the transportation device control program 164 of the warehouse control apparatus 100 from the transportation device 1. The device information is information of the transportation device 1 that is instructed to start transportation in step S5 of FIG. 3 or the like.

The device information 260 includes a device ID 261, an operation status 262, a remaining battery capacity 263, load information 264, position information 265, and comprehensive determination 266 in one record.

The device ID 261 stores the identifier assigned to the transportation device 1. The operation status 262 indicates the status of the transportation device 1 and stores the status of operating, waiting, moving, stopping, charging, and the like. The remaining battery capacity 263 stores the remaining capacity (ratio) of the battery of the transportation device 1.

The load information 264 stores the information of the load accumulated in the transportation device 1 (travel time, travel distance, and the like). The position information 265 stores the position of the transportation device 1 in the warehouse. In the present embodiment, an example in which the floor surface in the storage space 12 is partitioned into a grid pattern, and positions are assigned is provided.

The comprehensive determination 266 stores the status of the transportation device 1 determined by the transportation device control program 164 based on the remaining battery capacity 263 or the load information 264. For example, the comprehensive determination 266 indicates usable in case of “A”, indicates maintenance recommended in case of “B”, and indicates maintenance required in case of “C”.

Note that, the device information 260 can include information of the picking station 16 to be the transportation destination assigned to the transportation device 1, the operation status, cumulative load, and information indicating whether the device is normal.

The warehouse control apparatus 100 can calculate the predicted working time from the number of the transportation devices 1 heading to the picking station 16 and information indicating the presence or absence of the abnormality of the transportation device 1, from the device information 260, by correcting the working time of the corresponding picking station 16.

Also, when the index (for example, the number of operating devices) included in the device information 260 is lower than a predetermined threshold value, the calculation of the predicted working time may be corrected.

Note that, when the transportation device 1 corresponds to one or more specific picking stations 16 in advance, the processing described above is performed for each of the corresponding picking stations 16 and the transportation device 1.

FIG. 13 is a diagram illustrating an example of the worker work information 240. The worker work information 240 includes a worker ID 241, a length of service 242, a height 243, a work schedule including a date 244 and the time 245, and a status 246 in one record.

The worker ID 241 stores an identifier assigned to the worker 17. The length of service 242 stores work history of the worker 17. The height 243 stores the height of the worker 17. The date 244 and the time 245 stores the work schedule of the worker 17. The status 246 stores a value input according to the physical condition of the worker 17, the presence or absence of injury, and the like.

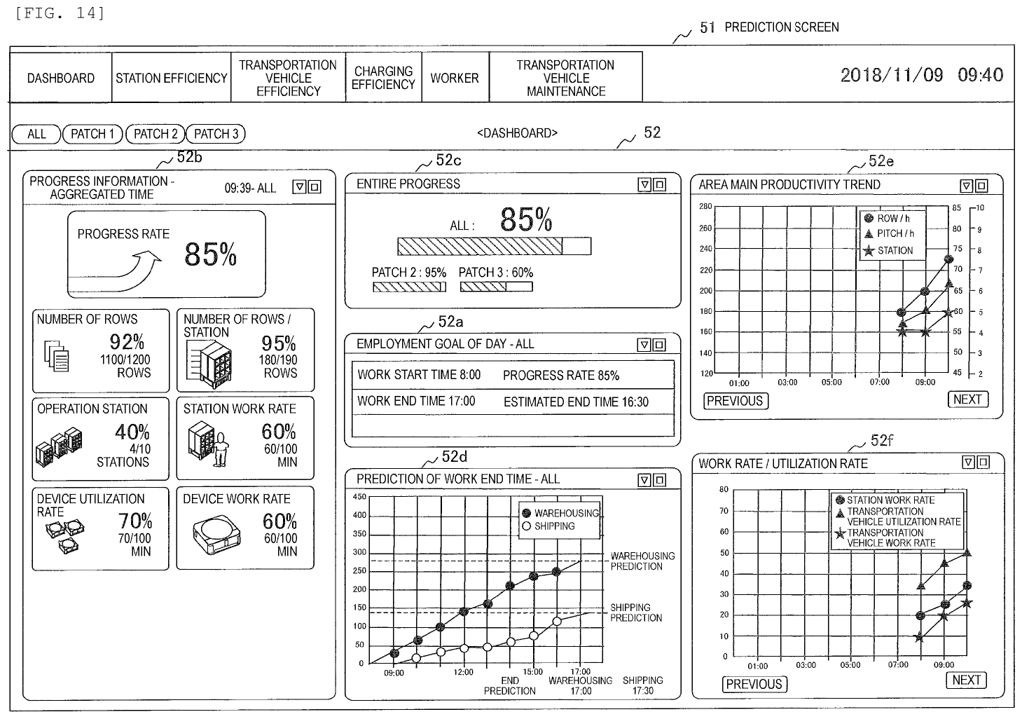

FIG. 14 is a diagram illustrating an example of the prediction screen 51. The prediction screen 51 is generated by the data analysis program 163 in step S11 of FIG. 3. The illustrated example is a screen obtained by displaying a dashboard 52 displaying the prediction result of the progress status of the job calculated by the data analysis program 163 to the output device 140. The display of the prediction screen 51 can be instructed from the input device 130 of the warehouse control apparatus 100.

The dashboard 52 includes a work goal window 52a that displays a target of the job or the progress status of the job related to the entire warehouse, a progress information window 52b that displays the progress status, the processing performance, or the like, an entire progress window 52c that displays the progress status of the entire warehouse, the work end time prediction window 52d that displays the predicted completion time of the entire warehouse, a main productivity trend window 52e that displays the productivity of the warehouse, and a work rate/utilization rate window 52f that displays the work rate and the utilization rate in the warehouse.

The work goal window 52a displays the work start time and the work end time of the day, the progress rate of the job at the current time, and the estimated end time. The work start time and the work end time are data set in the work schedule information 250.

The progress rate is a ratio occupied by the rows that are actually performed, among the number of rows to be processed for the shipping or the warehousing to be performed during the day in the station log 310 generated until the current time. The estimated end time is time predicted that the all jobs are completed at the current time.

The progress information window 52b displays a progress rate, the number of rows, the number of rows/station, an operation station, a station work rate, a device utilization rate, and a device work rate.

The progress rate indicates the same value of the entire warehouse as the progress rate of the work goal window 52a. The number of rows indicates a ratio occupied by the rows that are actually performed, among the number of rows to be processed for all the job of the work schedule information 250 to be executed during the day from the station performance data 320 generated until the current time and the worker performance data 330.

The number of rows/station indicates a ratio occupied by rows that are actually performed (may be a numerical value of the specific picking station 16 or may be a numerical value of the entire picking stations 16 in the warehouse) among the number of rows to be processed for the warehousing job work and the shipping job to be performed during the day, in the station performance data 320 and the work schedule information 250 that are generated until the current time.

The operation station indicates a ratio occupied by the number of the picking stations 16 that are operated at least once during the past n minutes (for example, 10 minutes) from the current time among the entire number of the picking stations 16.

The station work rate indicates the ratio (may be a numerical value of the specific picking station 16 or may be a numerical value of the entire picking stations 16 in the warehouse) occupied by the time when the shipping job or the warehousing job is performed in the picking station 16 in the elapsed time from the work start time to the current time.

The device utilization rate indicates a ratio (may be a numerical value of the specific transportation device 1 and may be a numerical value of the entire transportation device 1) occupied by the sum of the time when the transportation device 1 performs an “allocated work” and a “non-allocated work” or “charging” during the elapsed time from the work start time to the current time.

The device work rate indicates a ratio (may be a numerical value of the specific transportation device 1 and may be a numerical value of the entire transportation device 1) occupied by the sum of the time when the transportation device 1 performs an “allocated work” during the elapsed time from the work start time to the current time.

The entire progress window 52c displays values of the entire progress, Batch 2, and Batch 3 in a graph. The entire progress has the same value as the progress rate of the work goal window 52a. Batch 2 indicates the progress rate at the time retrospective by a predetermined period of time (for example, 60 minutes) from the current time. Batch 3 indicates a progress rate at the time retrospective by a predetermined period of time (for example, 120 minutes) from the current time.

The work end time prediction window 52d displays the values of the warehousing prediction and the shipping prediction in a graph. Note that, the horizontal axis of the graph is time, and the vertical axis is the quantity of the product. The warehousing prediction is indicated by a line segment connecting the origin, the predicted warehousing end time, and the predicted warehousing quantity. The shipping prediction is indicated by a line segment connecting the origin, the predicted shipping end time, the predicted shipping quantity. Note that, the warehousing indicates the time-series cumulative quantity of the products actually stocked in warehouse. Also, the shipping indicates a time-series cumulative quantity of the products actually shipped.

The main productivity trend window 52e displays the values of the number of rows/h, the number of picks/h, and the number of operation stations in the graph. Note that, the horizontal axis of the graph is the time, and the vertical axes are the number of rows (left scale) and the number of times and the number of stations (right scale).

The number of rows/h indicates the time-series cumulative value of the number of rows to be processed for instructing works performed for one hour. The number of picks/h indicates the time-series cumulative value of the number of times of the shipping job (or warehousing job) performed for one hour. The number of operation stations indicates the time-series cumulative value of the number of the picking stations 16 that perform the work at least once during the past n minutes (for example, 10 minutes) from the current time.

The work rate/utilization rate window 52f displays the values of station work rate, the transportation device utilization rate, and the transportation device work rate in a graph. Note that, the horizontal axis of the graph is time, and the vertical axis is the work rate or the utilization rate.

The station work rate indicates the time-series trend of the station work rate of the progress information window 52b. The transportation device utilization rate indicates the time-series trend of the transportation device utilization rate of the progress information window 52b. The transportation device work rate indicates the time-series trend of the transportation device work rate of the progress information window 52b.

Note that, the prediction screen 51 is not limited to the above and can be appropriately changed according to the operational status of the distribution center or the warehouse or the like. For example, as illustrated in FIG. 18, the work end time prediction window 52d may display time when the job is to be completed (estimated completion time 522) and the predicted completion time (predicted completion time 523) in the ascending order of delays 524 of the job at the picking stations 16 (station IDs 521).

The manager of the warehouse can easily and quickly grasp the picking station 16 at which the job is delayed in the warehouse and the degree of the delay by the work end time prediction window 52d.

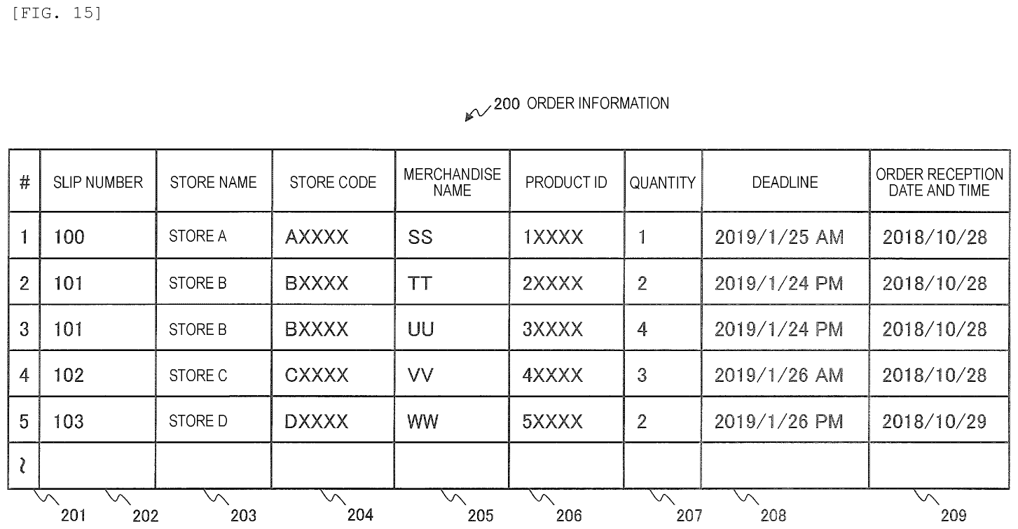

FIG. 15 is a diagram illustrating an example of the order information 200. The order information 200 includes a serial number 201, a slip number 202, a store name 203, a store code 204, a merchandise name 205, a merchandise code 206, the quantity 207, a deadline 208, and order reception date and time 209 in one record.

The serial number 201 is a unique number assigned by the warehouse control apparatus 100. The slip number 202 is a unique number assigned by the warehouse control apparatus 100 per order. The store name 203 indicates the shipment destination of the product.

In the present embodiment, an example in which, even when the slip numbers 202 are the same, in a case where the merchandise names 205 and the merchandise codes 206 are different, the different serial numbers 201 are assigned is provided. This is because when the merchandise names 205 and the merchandise codes 206 are different, it is likely that the shelves 8 where the merchandises are respectively stored are different.

The quantity 207 indicates an ordered number of the merchandises specified by the merchandise name 205 and the merchandise code 206 in the slip number 202 of the corresponding record. In the order reception date and time 209, the date and time when the warehouse control apparatus 100 (or distribution center) receives the order of the slip number 202 is stored.

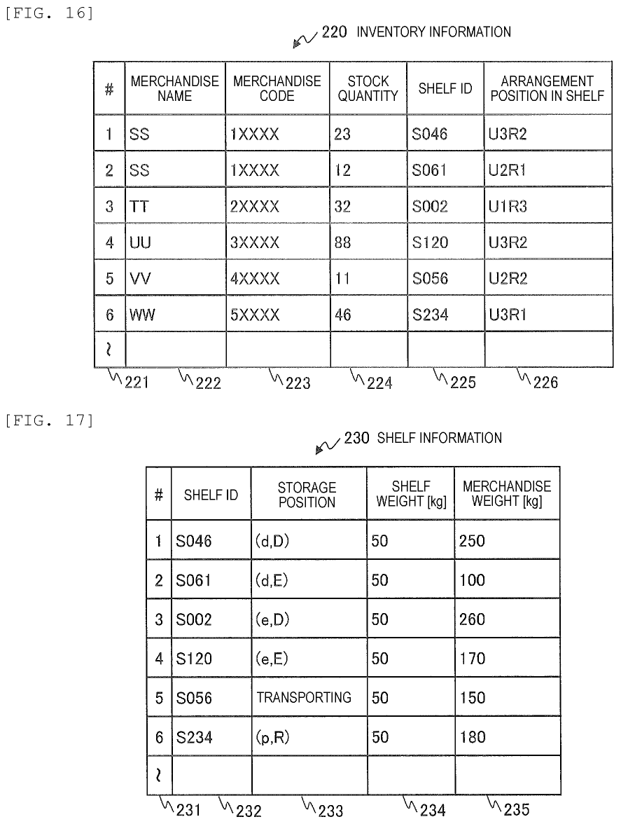

FIG. 16 is a diagram illustrating an example of the inventory information 220. The inventory information 220 includes a serial number 221, a merchandise name 222, a merchandise code 223, a stock quantity 224, a shelf ID 225, and an arrangement position in the shelf 226 in one record.

The shelf ID 225 stores the identifier of the shelf 8 where the product is stored. The arrangement position in the shelf 226 stores, for example, information used when the worker 17 or a robot 18 performs the picking worker at the picking station 16. For example, in a record described as “U3R2”, the arrangement position in the shelf 226 indicates that the target product is arranged on “the third from the top (U) and the second position from the right (R)” in the shelf 8.

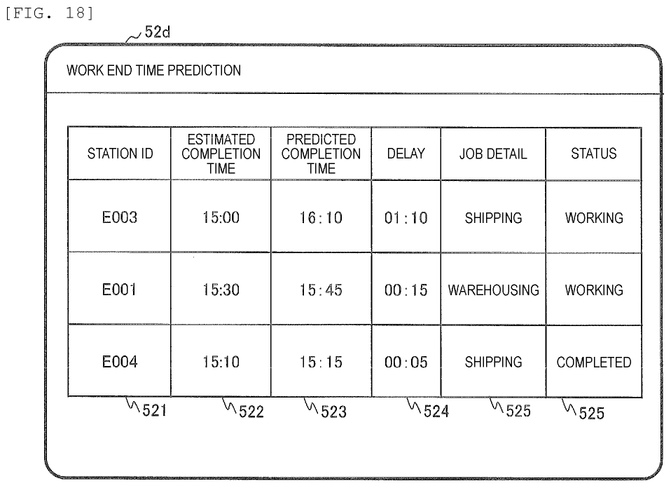

FIG. 17 is a diagram illustrating an example of the shelf information 230. The shelf information 230 includes a serial number 231, a shelf ID 232, a storage position 233, a shelf weight 234, and a merchandise weight 235 in one record.

The shelf ID 232 stores a unique identifier assigned to each shelf 8. As the shelf ID 232, for example, the identifier of the shelf 8 that is assigned by the warehouse control apparatus 100 may be stored. The storage position 233 stores position information of the storage space 12 where the shelf 8 is stored, and for example, coordinates of the map information is stored. When the shelf 8 is transported, “transporting” is stored in the storage position 233.

The shelf weight 234 stores the weight of the shelf 8 itself, and the merchandise weight 235 stores the weight of product (merchandise, a container for storing the merchandise, and the like) loaded on the shelf 8. The weight of the transported object (shelf+merchandise) transported by the transportation device 1 becomes at least the sum of the “shelf weight” and the “merchandise weight”.

For example, in the inventory information 220 or the like of FIG. 16, the weight of each product, the stock quantity, and the like may be recorded, and for example, the weight of the transported object (shelf+product) may be obtained by calculation. Note that, when the “weight” is obtained by calculation, if the weight falls within an acceptable range of an error between the weight of the actually transported object and the calculated value, some of weights of the shelf 8 and the products loaded on the shelf 8 may not be included in the calculation.

In addition, as another example, for example, a weight sensor that can measure a “weight of a transported object (shelf +product)” transported by the transportation device 1 is loaded, and the weight may be measured when the shelf 8 after picking is completed is returned to the storage position. At this time, the weight measured in the transportation device 1 may be received by the warehouse control apparatus 100 and may be recorded as the corresponding “weight of the transported object (shelf+merchandise)” in the shelf information 230.

### <Prediction Data Generation>

Next, the generation processing of the work prediction data performed in step S10 of FIG. 3 is described. The warehouse control apparatus 100 calculates the average value of the working time per picking station 16 with respect to the periods A to D with different lengths per type of the work in step S9 of FIG. 3 and stores the average value in the period performance data 340.

That is, the period performance data 340 stores the average time of the picking work, the average time of the assortment work, the average time of the departure work, and the average time of the waiting time per picking station 16 with respect to the periods A to D, respectively.

Next, in step S10 of FIG. 3, the warehouse control apparatus 100 calculates the predicted completion time 295 of each work per picking station 16 by using the period performance data 340 and the weighting coefficient 350. The warehouse control apparatus 100 calculates predicted time of each work (predicted picking time, predicted assortment time, predicted departure time, and predicted waiting time) from Equation (2) below, respectively.

$$\begin{matrix}[ Numerical Formula 1 ] & \\ [ \begin{matrix}Predicted Picking Time \\ Predicted Assortment Time \\ Predicted Departure Time \\ Predicted Waiting Time\end{matrix} ] of Each ST = Period A Average \times 0.3 ( Coefficient A ) + Period B Average \times 0.3 ( Coefficient B ) + Period C Average \times 0.15 ( Coefficient C ) + Period D Average \times 0.05 ( Coefficient D ) & ( 2 )\end{matrix}$$

In Equation (2), the period A average to the period D average are the period A average 343 to the period D average 346 per work detail 342 of the period performance data 340 of FIG. 7A, and the coefficient A to the coefficient D are the coefficient A 352 to the coefficient D 355 of the weighting coefficient 350 of FIG. 9.

Also, as the coefficient A 352 to the coefficient D 355, weighting coefficients unique to the picking station 16 may be used as described above, or weighting coefficients for the entire warehouse can be used.

Values obtained by adding the predicted picking time, the predicted assortment time, the predicted departure time, and the predicted waiting time respectively to predicted start time (298) becomes the predicted end time of the prediction data 290 of FIG. 11 (the predicted start time/predicted end time 298). Note that, each predicted time becomes predicted working time obtained by predicting the working time of the work currently performed based on performance data (the station performance data 320 and the worker performance data 330) per work detail.

Next, it is assumed that the corresponding job (the processing ID 251) is performed at the plurality of picking stations 16, the warehouse control apparatus 100 calculates predicted time of the corresponding job from Equation (3).

$$\begin{matrix}[ Numerical Formula 2 ] & \\ [ \begin{matrix}Predicted Picking Time per Job \\ Predicted Assortment Time per Job \\ Predicted departure Time per Job \\ Predicted Waiting Time per Job\end{matrix} ] = \frac{{\sum }_{Operating St} Predicted Time of Each Job at Each Operating ST}{Number of Operating STs} & ( 3 )\end{matrix}$$

The predicted time until the job configured with each work of the entire picking station 16 at which the corresponding job (the processing ID 251) is performed ends is calculated as a value obtained by summing up values obtained by dividing the sum of the predicted picking time, the predicted assortment time, the predicted departure time, and the predicted waiting time of each picking station 16 by the number of the picking stations 16 (the number of operating STs in the drawing) at which the corresponding job is performed, from Equation (3).

The predicted time until each work ends is calculated as predicted picking time per job, predicted assortment time per job, predicted departure time per job, and predicted waiting time per job.

Next, the warehouse control apparatus 100 calculates predicted completion time of the corresponding job (the processing ID 251) from Equation (4).

$$\begin{matrix}[ Numerical Formula 3 ] & \\ Predicted Completion Time = ( Predicted Picking Time Per Job + Predicted Assortment Time Per Job + Predicted Departure Time Per Job + Predicted Waiting Time Per Job ) \times ( Remaining Number of Rows / Number of Operating STs ) & ( 4 )\end{matrix}$$

In Equation (4), the remaining number of rows indicates the number of records of the unprocessed product ID 256 in the record of the processing ID 251 of the corresponding job. Also, the value obtained by dividing the value obtained by subtracting the number of records of the unprocessed product ID 256 from the total number of the records with the same processing ID 251 by the total number of records with the same processing ID 251 can be set as the progress rate.

From the above, the value obtained by dividing the number of rows of the work schedule information 250 for performing the shipping job or the warehousing job to the sum of the predicted time of each work of a job unit by the number of the picking stations 16 of the corresponding job (the number of operating STs) is calculated as the predicted time until the corresponding job is completed from the current time.

A value obtained by adding the estimated completion time in Equation (4) above to the current time is calculated as the predicted completion time 295 of the prediction data 290. Also, the data analysis program 163 of the warehouse control apparatus 100 can also calculate the progress rate per picking station 16 and display the progress rate on the prediction screen 51.

In the warehouse control apparatus 100 according to the present embodiment as above, it is possible to predict the working time with high accuracy based on various variable factors by predicting working time until the job is completed based on the average value of the working time of the plurality of periods with different lengths per type of each work.

When the date for calculating the predicted completion time 295 corresponds to the date of the work day characteristic 280 illustrated in FIG. 8, the correction coefficient of FIG. 8 may be multiplied by the estimated completion time calculated in Equation (4). Thereby, the estimated completion time can be corrected with the correction coefficient 284 according to an event specific to the date when the shipping job or the warehousing job is to be performed, and thus prediction accuracy can be improved.

Note that, when the predicted working time of the current work (work on the first work day) is estimated, in a case where the work day characteristic 280 of the previous and current work days satisfies the predetermined condition (the event 282), the performance data (the station performance data 320, the worker performance data 330) on one or more of the other work days satisfying the predetermined condition is acquired, and the predicted working time can be estimated based on the corresponding performance data.

Also, by gradually decreasing the values of the coefficient A 352 to the coefficient D 355 of the weighting coefficient 350 illustrated in FIG. 9 from the current time to the past, the recent work performance strongly reflects the deviation of the status of the worker 17 or temporary order, whereas the work performance over a long period of time can reflect various fluctuations in various working time due to the occurrence of the deviation in the types and locations of merchandise shipped according to the season and trends.

Note that, in the above example, an example in which the worker 17 operates the station terminal 7 installed at the picking station 16 is provided, but the present embodiment is not limited thereto. For example, communication with the warehouse control apparatus 100 may be performed with a mobile terminal such as a smartphone or a smart watch, to receive the instruction of the work and transmit the progress status of the work.

### <Conclusion>

Note that, the information processing system according to the embodiment can be configured as below.

(1) An information processing system including: a warehouse control apparatus (100) including a processor (the calculation device 110) and a memory (120); a transportation device (1) that can transport a storage portion that stores a product according to a transportation instruction from the warehouse control apparatus (100); and a terminal (the station terminal 7) that transmits and receives work information in a work station (the picking station 16) that is connected to the warehouse control apparatus (100) and where at least one work related to warehousing or shipping to the product of storage portion (the shelf 8) is performed, in which the warehouse control apparatus (100) includes a storage unit (the data input/output program 162) that acquires information related to work performance in the work information related to at least one of the warehousing and the shipping in the work station (16) from the terminal (7) and stores the information as log information (the station log 310), and a control unit (the data analysis program 163) that generates a plurality of pieces of performance data (320, 330) that is information related to working time during a plurality of preset periods (A to D) with different lengths for each of the at least one work based on the log information (310) and estimates predicted working time (the estimated completion time 255) of each of the at least one work based on the plurality of pieces of performance data (320, 330).

With the configuration, the warehouse control apparatus 100 can accurately estimate time when a work ends based on the station performance data 320 and the worker performance data 330 during a plurality of periods with different lengths.

(2) In the information processing system according to (1), the plurality of periods (A to D) includes a first period (the period A) and a second period (the period D) longer than the first period (the period A), the first period (the period A) is a period when the work is performed by the first worker (17) who performs the work at the first work station (16) among the work stations (16), the second period (the period D) is a period when the work is performed at the first work station (16) by the plurality of workers (17), and the control unit (163) acquires first performance data (320, 330) that is information related to the working time of the work during the first period (the period A) and second performance data (320, 330) that is the information related to the working time of the work in the second period (the period D) and estimates predicted working time (255) when the first worker (17) performs the work at first work station (16) based on at least the first performance data (320, 330) and the second performance data (320, 330).

With the configuration, the warehouse control apparatus 100 can estimate the working time in which the performance depending on the worker is reflected to the short period A, and the environment of the picking station 16 that is not limited due to the effect of the specific worker 17 is reflected to the long period D.

(3) In the information processing system according to (1), the plurality of periods (A to D) include a first period (the period A) and a second period (the period D) longer than the first period (the period A), the first period (the period A) is a period from first time to second time in a specific work day, and the second period (the period D) includes at least a plurality of work days.

With the configuration, the warehouse control apparatus 100 can improve estimation accuracy of the working time by using the first period in which recent work efficiency greatly depending on the workers 17 or the like is reflected and the second period in which work efficiency that changes according to a long-term trend of a type or an amount of a product is reflected.

(4) In the information processing system according to (1), the storage unit (162) further includes information indicating characteristics per work day, and when the predicted working time (255) of the work on the first work day is estimated, in a case where a characteristic (the work day characteristic 280) of the first work day satisfies the predetermined condition (the event 282), the control unit (163) acquires performance data (320, 330) related to working time of the work on one or more second work days that satisfy the predetermined condition (282) and estimates the predicted working time (255) based on the corresponding performance data (320, 330).

With the configuration, the warehouse control apparatus 100 refers to the station performance data 320 or the worker performance data 330 in the past of which characteristic of the work day is similar and predicts the current working time so that the prediction accuracy of the working time on a specific work day can be secured.

(5) In the information processing system according to (4), a case where the characteristic (280) of the first work day satisfies the predetermined condition (282) is that the first work day is a day (281) related to a specific event (282).

With the configuration, the warehouse control apparatus 100 refers to the station performance data 320 or the worker performance data 330 in the past of which the characteristic of the work day is similar, and the prediction accuracy of the working time on the work day when the specific event 282 occurs can be secured.

(6) In the information processing system according to (1), the control unit (163) estimates predicted working time (255) of each of the at least one work by calculating a weighted average of the plurality of pieces of performance data (320, 330), the plurality of pieces of performance data (320, 330) include first performance data (320, 330) that is information related to working time during the first period (the period A) and second performance data (320, 330) that is information related to working time in the second period (the period D) longer than the first period (the period A), and weighting data corresponding to the second performance data (320, 330) is set as a smaller value than a weighting coefficient corresponding to the first performance data (320, 330) with respect to weighting coefficients respectively corresponding to the plurality of pieces of performance data (320, 330) in calculation of an weighted average of the plurality of pieces of performance data (320, 330).

With the above configuration, the warehouse control apparatus 100 can strongly reflect the effect of the recent worker 17 or the like by setting the value of the weighting coefficient 350 to be smaller as the period D is longer, when the period performance data 340 for each of the different periods A to D is calculated by a weighted average.

(7) In the information processing system according to (1), the storage unit (162) acquires information related to the work performance from the plurality of work stations (16) and stores the information as the log information (310), and the control unit (163) acquires the plurality of pieces of work performance data (320, 330) per work station (16) and estimates the predicted working time (255) per work station (16).

By the configuration, the warehouse control apparatus 100 can predict the working time in case of the environment of the picking station 16 and thus can improve the prediction accuracy of the working time of the entire warehouse.

(8) In the information processing system according to (7), in at least one work station (16) included in the plurality of work stations (16), the work is performed by the plurality of workers (17).

With the above configuration, the warehouse control apparatus 100 acquires performance data per picking station 16 when the plurality of workers 17 take turns working at the same picking station 16, and thus it is possible to predict working time according to the environment of the picking station 16 that is not limited to a specific worker.

(9) In the information processing system according to (1), the storage (162) stores the transportation device information (the device information 260) including at least information related to an operation status of the plurality of transportation devices (1), and the control unit (163) estimates the predicted working time (255) based on the plurality of pieces of work performance data (320, 330) and the plurality of pieces of transportation device information (260).

With the above configuration, the warehouse control apparatus 100 can improve the prediction accuracy by estimating the working time in consideration of information of the transportation device 1.

(10) In the information processing system according to (1), the storage unit (162) stores worker (17) information that is information of the workers (17) who perform the work at the plurality of work stations (16) and stores the information in the log information (310), and the control unit (163) estimates the predicted working time (255) based on the plurality of pieces of work performance data (320, 330) and the worker (17) information.

With the above configuration, the warehouse control apparatus 100 considers the difference of the working time caused by the difference of the environment per picking station 16 based on the information of the worker 17 and can improve the accuracy of the prediction data 290.

(11) In the information processing system according to (1), the at least one work includes a picking work that is performed on the storage portion (8), and the control unit (163) estimates the predicted working time (255) of the picking work based on the plurality of items of performance data (320, 330).

With the configuration, the warehouse control apparatus 100 can predict working time of the picking work performed at the picking station 16.

(12) In the information processing system according to (1) 1, the control unit (163) acquires load information (337) related to a workload according to a work detail of the picking work and estimates the predicted working time (255) of the picking work based on the corresponding load information (337) and the plurality of pieces of performance data (320, 330).

With the above configuration, the warehouse control apparatus 100 can improve the prediction accuracy by predicting the working time in consideration of the load of the worker 17 who performs the picking work.

(13) In the information processing system according to (1), the at least one work includes an assortment work of sorting the product picked from the storage portion (8), and the control unit (163) estimates the predicted working time (255) of assortment work based on the plurality of pieces of performance data (320, 330).

With the configuration, the warehouse control apparatus 100 can predict the working time of the assortment work performed at the picking station 16.

(14) In the information processing system according to (1), the at least one work includes a departure work of starting the transportation of the storage portion (8) after the picking work performed on the storage portion (8) by the transportation device (1), and the control unit (163) estimates the predicted working time (255) according to the departure work based on the plurality of pieces of performance data (320, 330).

With the above configuration, the warehouse control apparatus 100 can predict the working time of the departure work performed at the picking station 16.

(15) In the information processing system according to (1), the log information (310) includes information of time when the work station (16) is in the waiting status without performing the at least one work, and the control unit (163) acquires the information related to time when the work station (16) is in the waiting status in the plurality of preset periods (A to D) with different lengths and estimates the predicted waiting time when the work station (16) is in the waiting status based on the corresponding information.

With the above configuration, the warehouse control apparatus 100 can estimate and predict the predicted waiting time when the picking station 16 becomes in the waiting status.

(16) In the information processing system according to (15), the at least one work includes at least a picking work performed on the storage portion (8), the assortment work of sorting the product picked from the storage portion (8), and the departure work of starting transportation of the storage portion (8) after the picking work performed on the storage portion (8) by the transportation device (1), the storage unit (162) includes work schedule information (250) related to any one or both of the work of the warehousing and shipping to be performed on the predetermined work day, and the control unit (163) estimates predicted end time (the estimated completion time 255) that is date and time when completion of any one or both of the works of the warehousing work and the shipping work is predicted on the predetermined work day based on the predicted working time (255), the predicted waiting time, and the work schedule information (250) for each of the at least one work.

With the configuration, the warehouse control apparatus 100 can accurately estimate completion time of the warehousing and shipping work on the predetermined work day.

(17) The information processing system according to (16) includes an output device that visually displays the predicted end time (the estimated completion time 255) of the predetermined work day at the current time.

With the above configuration, the warehouse control apparatus 100 can visualize and display the estimated completion time 255 with respect to the work on the predetermined work day at the current time.

Note that, the present invention is not limited to the above-described embodiments and includes various modifications. For example, the embodiments described above are described in detail to explain the present invention in an easy-to-understand manner and are not limited to necessarily including all the configurations described. Furthermore, a part of the configuration of one embodiment can be replaced with the configuration of another embodiment, and the configuration of another embodiment can also be added to the configuration of one embodiment. Further, addition, deletion, or replacement of other components to a part of the configuration of each embodiment can be applied singly or in combination.

Further, each of the above-mentioned configurations, functions, processing units, processing means, and the like may be partially or entirely realized in hardware for example, by designing with an integrated circuit. Also, each of the above-mentioned configurations, functions, and the like may be realized by software by a processor interpreting and executing a program that realizes each function. Information such as programs, tables, files, and the like that realize each function can be stored in a memory, a recording device such as a hard disk and a Solid State Drive (SSD), or a recording medium such as an IC card, an SD card, or a DVD.

Further, only the control lines and information lines necessary for purpose of description are illustrated, and not all control lines and information lines are necessarily illustrated in the product. In reality, almost all components may be considered to be interconnected.

1. An information processing system comprising:
a warehouse control apparatus that includes a processor and a memory;
a transportation device that can transport a storage portion storing a product according to a transportation instruction from the warehouse control apparatus; and
a terminal that transmits and receives work information at a work station that is connected to the warehouse control apparatus and where at least one work related to warehousing or shipping is performed on the product of the storage portion,
wherein the warehouse control apparatus includes
a storage unit that acquires information related to work performance in the work information related to at least one of warehousing and shipping in the work station from the terminal and stores the information as log information, and
a control unit that generates a plurality of pieces of performance data that is information related to working time during a plurality of preset periods with different lengths per type of the at least one work based on the log information and estimates predicted working time of each of the at least one work based on the plurality of pieces of performance data.

2. The information processing system according to claim 1, wherein
the plurality of periods include a first period and a second period longer than the first period,
the first period is a period when a work is performed by a first worker who performs the work at a first work station among the work stations,
the second period is a period when the work is performed at a first work station by a plurality of workers, and
the control unit acquires first performance data that is information related to working time of the work during the first period and second performance data that is information related to working time of the work during the second period and estimates predicted working time when the first worker performs the work at the first work station based on at least the first performance data and the second performance data.

3. The information processing system according to claim 1, wherein
the plurality of periods include a first period and a second period longer than the first period,
the first period is a period from first time to second time on a specific work day, and
the second period includes at least a plurality of work days.

4. The information processing system according to claim 1, wherein
the storage unit further includes information indicating a characteristic per work day, and
when the control unit estimates the predicted working time of the work on a first work day, in a case where the characteristic of the first work day satisfies a predetermined condition, the control unit acquires performance data related to working time of the work on one or more second work days that satisfy the predetermined condition and estimates the predicted working time based on the corresponding performance data.

5. The information processing system according to claim 4, wherein a case where the characteristic of the first work day satisfies the predetermined condition is that the first work day is a day related to a specific event.

6. The information processing system according to claim 1, wherein
the control unit calculates a weighted average of the plurality of pieces of performance data to estimate the predicted working time for each of the at least one work,
the plurality of pieces of performance data includes first performance data that is information related to working time during a first period and second performance data that is information related to working time in a second period longer than the first period, and
with respect to weighting coefficients respectively corresponding to the plurality of pieces of performance data in the calculation of the weighted average of the plurality of pieces of performance data, weighting data corresponding to the second performance data is set to a smaller value than a weighting coefficient corresponding to the first performance data.

7. The information processing system according to claim 1, wherein
the storage unit acquires information related to the work performance from a plurality of the work stations, stores the information as the log information, and
the control unit acquires the plurality of pieces of work performance data per work station and estimates the predicted working time per work station.

8. The information processing system according to claim 7, wherein the work is performed by a plurality of workers at at least one work station included in the plurality of work stations.

9. The information processing system according to claim 1, wherein
the storage unit stores transportation device information including at least information related to operation statuses of the plurality of transportation devices, and
the control unit estimates the predicted working time based on the plurality of pieces of work performance data and the transportation device information.

10. The information processing system according to claim 1, wherein
the storage unit stores worker information that is information of a worker who performs the work at a plurality of the work stations and stores the worker information in the log information, and
the control unit estimates the predicted working time based on the plurality of pieces of work performance data and the worker information.

11. The information processing system according to claim 1, wherein
the at least one work includes a picking work performed on the storage portion, and
the control unit estimates the predicted working time of the picking work based on the plurality of pieces of performance data.

12. The information processing system according to claim 11, wherein the control unit acquires load information related to workload according to a work detail of the picking work and estimates the predicted working time of the picking work based on the corresponding load information and the plurality of pieces of performance data.

13. The information processing system according to claim 1, wherein
the at least one work includes an assortment work of sorting a product picked from the storage portion, and
the control unit estimates the predicted working time of the assortment work based on the plurality of pieces of performance data.

14. The information processing system according to claim 1, wherein
the at least one work includes a departure work of starting transportation of the storage portion after a picking work performed on the storage portion by the transportation device, and
the control unit estimates the predicted working time corresponding to the departure work based on the plurality of pieces of performance data.

15. The information processing system according to claim 1, wherein
the log information includes information of time when the work station is in a waiting status without performing the at least one work, and
the control unit acquires information related to the time when the work station is in the waiting status during the plurality of preset periods with different lengths and estimates predicted waiting time when the work station is in the waiting status based on the corresponding information.

16. The information processing system according to claim 15, wherein
the at least one work includes at least a picking work performed on the storage portion, an assortment work of sorting a product picked from the storage portion, and a departure work of starting transportation of the storage portion after the picking work performed storage portion by the transportation device,
the storage unit includes work schedule information related to any one or both of the works of warehousing and shipping to be performed on a predetermined work day, and
the control unit estimates predicted end time that is date and time when completion of any one or both of the works of the warehousing work and the shipping work is predicted on the predetermined work day based on the predicted working time, the predicted waiting time, and the work schedule information per type of the at least one work.

17. The information processing system according to claim 16, further comprising an output device that visually displays the predicted end time of the predetermined work day at current time.

18. A management method of a warehouse for predicting time related to a work by a warehouse control apparatus including:
the warehouse control apparatus that includes a processor and a memory; a transportation device that can transport a storage portion storing a product according to a transportation instruction from the warehouse control apparatus; and a terminal that transmits and receives work information at a work station that is connected to the warehouse control apparatus and where at least one work related to warehousing or shipping is performed on the product of the storage portion, the method comprising:
a storage step of acquiring information related to work performance in the work information related to at least one of warehousing and shipping in the work station from the terminal and storing the information as log information in the storage unit by the warehouse control apparatus;
a performance data generation step of generating a plurality of pieces of performance data that is information related to working time during a plurality of preset periods with different lengths per type of the at least one work by the warehouse control apparatus; and
a control step of estimating predicted working time of each of the at least one work based on the plurality of pieces of performance data by the warehouse control apparatus.

19. A warehouse control apparatus that includes a processor and a memory and predicts time related to a work, the apparatus comprising:
a storage unit that acquires information related to work performance in work information related to at least one of warehousing and shipping in a work station from a terminal that transmits and receives the work information in the work station where at least one work related to warehousing or shipping is performed on a product of a storage portion storing the product and stores the information as log information, and
a control unit that generates a plurality of pieces of performance data that is information related to working time during a plurality of preset periods with different lengths per type of the at least one work based on the log information and estimates predicted working time of each of the at least one work based on the plurality of pieces of current performance data.
